(19) United States
(12) Patent Application Publication
(10) Pub. No.: US 2007/0055040 A1
(43) Pub. Date: Mar. 8, 2007

(54) Method for the continuous synthesis of a liquid melamine resin

(76) Inventors: Manfred Ratzsch, Wilhering (AT); Hartmut Bucka, Eggendorf (DE); Frank Schroder, Albrechshain (DE); Steffen Pfeiffer, Linz (AT); Gunther Tappeiner, Linz (AT)

Correspondence Address: THE WEBB LAW FIRM, P.C., 700 KOPPERS BUILDING, 436 SEVENTH AVENUE, PITTSBURGH, PA, 15219, US

(21) Appl. No.: 10/553,449

(22) PCT Filed: Mar. 26, 2004
(86) PCT No.: PCT/EP04/03269

§ 371 Date: Oct. 23, 2006

(30) Foreign Application Priority Data
Apr. 16, 2003 (DE) 10318481.3

(51) Int. Cl. C08G 14/02; C08G 2/00

(52) U.S. Cl. 528/129; 528/230

(57) ABSTRACT

The invention relates to a method for synthesizing a liquid melamine resin, wherein: a) melamine, at least one aldehyde and at least one alcohol are fed to at least one first reactor operated continuously, in particular at least one agitated tank operated continuously and are reacted together, b) the reaction product that is obtained is fed to a solid-liquid phase separation device, c) a solids-rich phase that has been produced in the solid-liquid phase separation is fed back to at least one first reactor, and d) a phase devoid of solids that has been produced in the solid-liquid phase separation is subjected to additional processing steps. The invention thus provides an efficient continuous direct synthesis method for a liquid melamine resin.

The invention relates to a process according to the precharacterizing clause of Claim 1, a use of a melamine resin condensate according to Claim 24 and melamine products according to Claim 25.

Direct synthesis processes for the preparation of etherified melamine resin condensates are known.

According to DE-A 25 16 349 and U.S. patent application Ser. No. 4,425,466, etherified methylolaminotriazines can be prepared by reacting aminotriazines with formaldehyde and alcohols in the presence of strong organic acids at 80 to 130° C. The use of ion exchangers in the direct preparation of etherified formaldehyde resins is described in BE-A 623 888. These processes were not designed to be continuous throughout, which would actually be desirable for reasons relating to the economy of the process.

It is the object of the present invention to provide an efficient continuous direct synthesis process.

This object is achieved, according to the invention, by a process having the features of Claim 1.

According to the invention,

a) melamine, at least one aldehyde and at least one alcohol are fed to a continuous first reaction stage which has in particular at least one stirred vessel and are reacted therein,

b) the reaction mixture, in particular a suspension, is fed to a solid-liquid phase separation apparatus for separation into a solids-rich phase and a solids-poor phase,

c) the solids-rich phase present after the solid-liquid phase separation is recycled to the first reaction stage and

d) the solids-poor phase present after the solid-liquid phase separation is fed to further processing steps, in particular transported to a second reaction stage and further reacted there.

It is advantageous if the solids-rich phase is rich in undissolved melamine.

Advantageously, the reaction product is taken off as a suspension from an overflow of a reactor of the first reaction stage, in particular of the last reactor of the first reaction stage, and transported into the solid-liquid phase separation apparatus.

It is thus possible to operate this part-step of a complete direct synthesis process continuously, uniform progress of the reaction being achievable by the steady take-off of the reaction product and the recycling of the solids-rich phase.

Advantageously, the solid-liquid phase separation apparatus is in the form of a hydrocyclone, in the form of a centrifuge, in particular in the form of a disc centrifuge, or in the form of a filter.

A solution of formaldehyde (37% strength) in water and methanol is preferably used for the reaction in the first reactor.

It is furthermore advantageous to premix the reactants homogeneously in a continuous mixer before the first reaction stage.

The reaction advantageously takes place in at least one first reactor at temperatures between 70 and 140° C. and at a pressure between 2 and 30 bar.

Advantageously, after the solid-liquid phase separation apparatus, the solids-poor phase is fed to a continuous second reaction stage, in particular having at least one tubular reactor for further etherification. Advantageously, the reaction in the second reaction stage is carried out under acidic conditions, in particular at a pH between 5 and 6.

The use of heterogeneous acidic catalysts, such as, for example, acidic ion exchangers, is particularly advantageous. Suitable ion exchangers are, for example, ion exchangers based on styrene/divinylbenzene copolymers which are chloromethylated and aminated with trimethylolamine or based on sulphonated styrene/divinylbenzene copolymers.

It is also advantageous if homogeneous catalysts are mixed with the reaction mixture before the second reaction stage.

For thorough radial mixing in the second reaction stage, it is advantageous if at least one reactor of the second reaction stage has mixing elements, in particular static mixers and/or packings.

It is advantageous if the reaction product of the second reaction stage is adjusted to a pH of more than 9, in particular by metering in sodium hydroxide solution.

The reaction product of the second reaction stage is concentrated in at least one evaporation step.

By complete elimination of formaldehyde and partial condensation, the virtually solvent-free liquid melamine resin precondensate is advantageously modified in a third reaction stage. The third reaction stage is preferably carried out in the form of a continuous mixer, in particular in the form of a kneader.

C₄-C₁₈-Alcohols, diols of the type HO—R—OH and/or tetrahydric alcohols based on erythritol are optionally added to the melamine resin precondensate before, during and/or after the concentration, and these are reacted in the third reaction stage with the concentrated melamine resin precondensate, preferably in a mixer, in particular a kneader.

At least one diol of the type HO—R—OH having molar masses of 62 to 20 000 is advantageous, or a mixture of at least two diols of the type HO—R—OH having molar masses of 62 to 20 000 is used, it being possible for the substituent R to have one of the following structures
C₂-C₁₈-alkylene,
—CH(CH₃)—CH₂—O—(C₂-C₁₂)-alkylene-O—CH₂—CH (CH₃)—,
—CH(CH₃)—CH₂—O—(C₂-C₁₂)-arylene-O—CH₂—CH(CH₃)—,
—(CH₂—CH₂—CH₂—CH₂—CH₂—CO)ₓ—(CH₂—CHR)_{y}—,
—[CH₂—CH₂—O—CH₂—CH₂]ₙ—,
—[CH₂—CH(CH₃)—O—CH₂—CH(CH₃)]ₙ—
—[O—CH₂—CH₂—CH₂—CH₂]ₙ—,
—[(CH₂)₂₋₈—O—CO—(C₆-C₁₄)-arylene-CO—O—(CH₂)₂₋₈]ₙ—,
—[(CH₂)₂₋₈—O—CO—(C₂-C₁₂)-alkylene-CO—O—(CH₂)₂₋₈]ₙ—,
in which n=1 to 200; x=5 to 15;

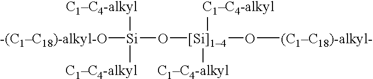

polyester sequences containing siloxane groups and of the type
—[(X)ᵣ—O—CO—(Y)ₛ—CO—O—(X)ᵣ]—,

in which
X=—{(CH₂)₂₋₈—O—CO—(C₆-C₁₄)-arylene-CO—O—(CH₂)₂₋₈}—
or
—{(CH₂)₂₋₈—O—CO—(C₂-C₁₂)-alkylene-CO—O—(CH₂)₂₋₈}—; 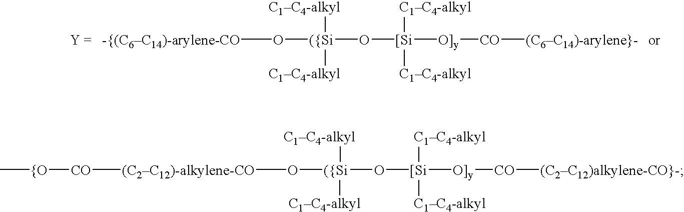
in which r denotes 1 to 70; s denotes 1 to 70 and y denotes 3 to 50;
polyether sequences containing siloxane groups and of the type 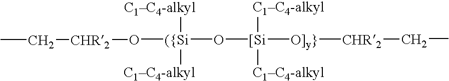
in which R′₂ denotes H; C₁-C₄-alkyl and y denotes 3 to 50;

sequences based on alkylene oxide adducts of melamine of the type 2-amino-4,6-di(C₂-C₄)alkyleneamino-1,3,5-triazine sequences

phenol ether sequences based on dihydric phenols and C₂-C₈-diols of the type —(C₂-C₈)alkylene-O—(C₆-C₁₈)-arylene-O—(C₂-C₈)-alkylene sequences.

Examples of diols of the type HO—R₁—OH, in which R₁ denotes C₂-C₁₈-alkylene, are ethylene glycol, butanediol, octanediol, dodecanediol and octadecanediol.

Examples of diols of the type HO—R₂—OH, in which

R₂ is —[CH₂—CH₂—O—CH₂—CH₂]ₙ— and n is 1-200, are polyethylene glycols having molar masses of 500 to 5000.

Examples of diols of the type HO—R₃—OH, in which R₃ is —[CH₂—CH(CH₃)—O—CH₂—CH(CH₃)]ₙ— and n is 1-200, are polypropylene glycols having molar masses of 500 to 5000.

Examples of diols of the type HO—R₄—OH, in which

R₄ is —[O—CH₂—CH₂—CH₂—CH₂]ₙ— and n is 1-200, are polytetrahydrofurans having molar masses of 500 to 5000.

Examples of diols of the type HO—R₃—OH, in which R₅ is —[CH₂)₂₋₈—O—CO—(C₆-C₁₄)-arylene-CO—O—(CH₂)₂₋₈]ₙ— and n is 1-200, are esters and polyesters based on saturated dicarboxylic acids, such as terephthalic acid, isophthalic acid or naphthalenedicarboxylic acid, and diols, such as ethylene glycol, butanediol, neopentylglycol and/or hexanediol. A preferred ester is bis(hydroxyethyl)terephthalate.

Examples of diols of the type HO—R₆—OH, in which R₆ is —[(CH₂)₂₋₈—O—CO—(C₂-C₁₂)-alkylene-CO—O—(CH₂)₂₋₈]ₙ— and n is 1-200, are polyesters based on saturated dicarboxylic acids, such as adipic acid and/or succinic acid, unsaturated dicarboxylic acids, such as maleic acid, fumaric acid and/or itaconic acid, and diols, such as ethylene glycol, butanediol, neopentylglycol and/or hexanediol.

Examples of diols of the type HO—R₇—OH, in which

R₇ denotes sequences containing siloxane groups and of the type 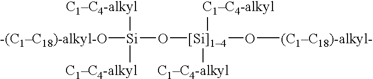
are 1,3-bis(hydroxybutyl)tetramethyldisiloxane and 1,3-bis(hydroxyoctyl)tetraethyldisiloxane.

Examples of polyester sequences with diols containing siloxane groups and of the type HO—R₈—OH, in which
R₈=—[(X)ᵣ—O—CO—(Y)ₛ—CO—O—(X)ᵣ]—, in which
   X=—{(CH₂₋₈—O—CO—(C₆-C₁₄)-arylene-CO—O—(CH₂)₂₋₈}—
   or
   —{(CH₂₋₈—O—CO—(C₂-C₁₂)-alkylene-CO—O—(CH₂)₂₋₈}—; 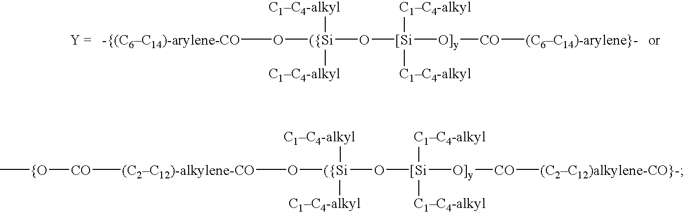
   in which r denotes 1 to 70; s denotes 1 to 70 and y denotes 3 to 50, are polyesters containing terminal hydroxyl groups and based on aromatic C₆-C₁₄-arylenedicarboxylic acids, such as terephthalic acid or naphthalenedicarboxylic acid, aliphatic C₂-C₁₂-alkylenedicarboxylic acids, such as adipic acid, maleic acid or pimelic acid, diols, such as ethylene glycol, butanediol, neopentylglycol or hexanediol, and siloxanes, such as hexamethyldisiloxane or α,ω-dihydroxypolydimethylsiloxane.

Examples of polyetherdiols HO—R₉—OH which contain siloxane groups and in which R₉ denotes polyether sequences of the type 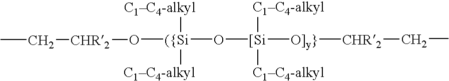
in which R′₂ denotes H; C₁-C₄-alkyl and y denotes 3 to 50, are polyetherdiols based on siloxanes, such as hexamethyldisiloxane or α,ω-dihydroxypolydimethyl-siloxane and alkylene oxides, such as ethylene oxide or propylene oxide.

Examples of diols based on alkylene oxide adducts of melamine of the type

2-amino-4,6-bis(hydroxy(C₂-C₄)alkyleneamino)-1,3,5-triazine

are diols based on melamine and ethylene oxide or propylene oxide.

Examples of phenoletherdiols based on dihydric phenols and C₂-C₈-diols of the type bis(hydroxy(C₂-C₈)alkylene-O—) (C₆-C₁₈)arylene are adducts of ethylene oxide or adducts of propylene oxide with diphenylolpropane.

In addition to diols as polyhydric alcohols, trihydric alcohols, such as glycerol, or tetrahydric alcohols based on erythritol or mixtures thereof with dihydric alcohols may likewise be used in the direct synthesis process.

If the addition of C₄-C₁₈-alcohols and/or diols of the type HO—R—OH is effected before the first evaporator stage and/or before the second evaporator stage, mixing zones are installed for homogenizing the components before the evaporator stages.

Advantageously, the etherified melamine resin condensates are mixtures having average molar masses of 500 to 2500 and comprising tris(methoxymethylamino)-triazine and higher molecular weight oligomers thereof.

Two evaporation steps are preferably carried out. For example, after a pH of less than 10 has been established, the etherified melamine resin precondensate is evaporated down in a first evaporator stage for separating off the water/methanol mixture at temperatures between 80 and 130° C. and at a pressure between 0.1 and 1.0 bar to a solids content of etherified melamine resin precondensate of 65% by mass to 85% by mass, and evaporated down in a second evaporator stage for achieving a solids content of etherified melamine resin precondensate of 95 to 99.9% by mass at 90 to 150° C. and 0.1 to 1 bar.

Before and/or during the concentration, i.e. before the first and/or before the second evaporator stage, and/or after the concentration, i.e. before the third reaction step, C₄-C₁₈-alcohols, diols of the type HO—R—OH and/or tetrahydric alcohols based on erythritol can be added to the melamine resin precondensate. The molar masses of the diols are preferably 62 to 20 000.

Before and/or during the concentration, i.e. before the first and/or before the second evaporator stage, and/or after the concentration, i.e. before the third reaction step, acids and/or acid anhydrides dissolved in alcohol or water may be added to the melamine resin precondensate.

By complete elimination of formaldehyde and partial condensation, the virtually solvent-free liquid melamine resin precondensate is modified in a third reaction stage and optionally reacted with alcohols and/or diols.

The third reaction stage is advantageously carried out in a continuous kneader. The reaction time in the kneader is about 2 to 12 min and the reaction temperature is 180° C. to 280° C. In the kneader, the removal of low molecular weight reaction products is effected by devolatilization, and the etherified melamine resin condensate is then discharged and granulated.

It is also possible to add to the continuous kneader up to 75% by mass of fillers and/or reinforcing fibres, further reactive polymers of the type consisting of ethylene copolymers, maleic anhydride copolymers, modified maleic anhydride copolymers, poly(meth)acrylates, polyamides, polyesters and/or polyurethanes, and up to 2% by mass, based in each case on the etherified melamine resin condensates, of stabilizers, UV absorbers and/or auxiliaries.

Continuous kneaders which may be used in the third reaction stage are twin-screw extruders which have devolatilization zones both after the feed zone and after the reaction zone. Such twin-screw extruders may have an L/D ratio of 36-60 with a corotating or counterrotating screw arrangement.

In principle, other, continuously operating machines which are at least partly self-purging, are suitable for the processing of highly viscous media and have vacuum devolatilization can also be used in principle as kneaders (e.g. Buss co kneader, single-screw extruder, extruders in a cascade arrangement, single-shaft or twin-shaft kneading machines of the type LIST ORP; CRP, Discotherm, etc.).

For separating off inhomogeneities, the melt can be transported into a melt filter by means of a gear pump. The conversion of the melt into granular particles can be effected in granulators or in tabletting units by metering the melt via a feed apparatus onto a continuous steel belt and cooling and solidifying the deposited tablets.

Examples of suitable fillers which can be metered into the continuous kneader in the direct synthesis process are: Al₂O₃, Al(OH)₃, barium sulphate, calcium carbonate, glass beads, silica, mica, quartz powder, ground slate, hollow microspheres, carbon black, talc, crushed rock, woodmeal, cellulose powder and/or shell and kernel flours, such as peanut shell flour or olive kernel flour. Preferred fillers are sheet silicates of the type consisting of montmorillonite, bentonite, kaolinite, muscovite, hectorite, fluorohectorite, kanemite, revdite, grumantite, ilerite, saponite, beidelite, nontronite, stevensite, laponite, taneolite, vermiculite, halloysite, volkonskoite, magadite, rectorite, kenyaite, suaconite, borofluorophlogopites and/or synthetic smectites.

Examples of suitable reinforcing fibres which may be metered into the continuous kneader in the direct synthesis process are inorganic fibres, in particular glass fibres and/or carbon fibres, natural fibres, in particular cellulose fibres, such as flax, jute, kenaf and wood fibres, and/or plastics fibres, in particular fibres of polyacrylonitrile, polyvinyl alcohol, polyvinyl acetate, polypropylene, polyesters and/or polyamides.

Examples of reactive polymers of the type consisting of ethylene copolymers which can be metered into the continuous kneader in the direct synthesis process are partly hydrolyzed ethylene/vinyl acetate copolymers, ethylene/butyl acrylate/acrylic acid copolymers, ethylene/hydroxyethyl acrylate copolymers or ethylene/butyl acrylate/glycidyl methacrylate copolymers.

Examples of reactive polymers of the type consisting of maleic anhydride copolymers which can be metered into the continuous kneader in the direct synthesis process are C₂-C₂₀-olefin/maleic anhydride copolymers or ethylene, propylene, 1-butene, isobutene, diisobutene, 1-hexene, 1-octene, 1-heptene, 1-pentene, 3-methylbut-1-ene, 4-methylpent-1-ene, methylethylpent-1-ene, ethylpent-1-ene, ethylhex-1-ene, 1-octadecene and 5,6-dimethylnorbornene.

Examples of the C₈-C₂₀-vinylaromatic components which may be contained in the maleic anhydride copolymers are styrene, α-methylstyrene, dimethylstyrene, isopropenyl-styrene, p-methylstyrene and vinylbiphenyl.

Examples of modified maleic anhydride copolymers which may be metered into the continuous kneader in the direct synthesis process are partially or completely esterified, amidated or imidated maleic anhydride copolymers.

Particularly suitable are modified copolymers from maleic anhydride and C₂-C₂₀-olefins or C₈-C₂₀-vinylaromatics with a molar ratio of 1:1 to 1:9 and weight average molar masses of 5000 to 500 000, which have been reacted with ammonia, C₁-C₁₈-monoalkylamines, C₆-C₁₈-aromatic monoamines, C₂-C₁₈-monoaminoalcohols, monoamidated poly(C₂-C₄-alkylene) oxides having a molar mass of 400 to 3000, and/or monoetherified poly(C₂-C₄-alkylene) oxides having a molar mass of 100 to 10 000, the molar ratio of the anhydride groups on the copolymers to ammonia, amino groups of C₁-C₁₈-monoalkylamines, C₆-C₁₈-aromatic monoamines, C₂-C₁₈-monoaminoalcohols or monoaminated poly(C₂-C₄-alkylene) oxide and/or hydroxyl groups of poly(C₂-C₄-alkylene) oxide being 1:1 to 20:1.

Examples of reactive polymers of the poly(meth)acrylate type which can be metered into the continuous kneader in the direct synthesis process are copolymers based on functional unsaturated (meth)acrylate monomers, such as acrylic acid, hydroxyethyl acrylate, glycidyl acrylate, methacrylic acid, hydroxybutyl methacrylate or glycidyl methacrylate, and nonfunctional unsaturated (meth)acrylate monomers, such as ethyl acrylate, butyl acrylate, ethylhexyl acrylate, methyl methacrylate, ethyl acrylate and/or butyl methacrylate, and/or C₈-C₂₀-vinylaromatics. Copolymers based on methacrylic acid, hydroxyethyl acrylate, methyl methacrylate and styrene are preferred.

Examples of reactive polymers of the polyamide type which can be metered into the continuous kneader in the direct synthesis process are polyamide-6, polyamide-6,6, polyamide-11, polyamide-12, polyaminoamides obtained from polycarboxylic acids and polyalkyleneamines and the corresponding methoxylated polyamides.

Examples of reactive polymers of the polyester type which can be metered into the continuous kneader in the direct synthesis process are polyesters having molar mas-ses of 2000 to 15 000 and obtained from saturated dicarboxylic acids, such as phthalic acid, isophthalic acid, adipic acid and/or succinic acid, unsaturated dicarboxylic acids, such as maleic acid, fumaric acid and/or itaconic acid, and diols, such as ethylene glycol, butanediol, neopentylglycol and/or hexanediol. Branched polyesters based on neopentylglycol, trimethylolpropane, isophthalic acid and azelaic acid are preferred.

Examples of reactive polymers of the polyurethane type which can be metered into the continuous kneader in the direct synthesis process are uncrosslinked polyurethanes based on toluene diisocyanate, diphenylmethane diisocyanate, butane diisocyanate and/or hexane diisocyanate as diisocyanate components and butanediol, hexanediol and/or polyalkylene glycols as diol components having molar masses of 200 to 30 000.

Examples of suitable stabilizers and UV absorbers which can be metered into the continuous kneader in the direct synthesis process are piperidine derivatives, benzophenone derivatives, benzotriazole derivatives, triazine derivatives and/or benzofuranone derivatives.

Examples of suitable auxiliaries which can be metered into the continuous kneader in the direct synthesis process are latent curing agents, such as ammonium sulphate and/or ammonium chloride, and/or processing auxiliaries, such as calcium stearate, magnesium stearate and/or wax.

The etherified melamine resin condensates prepared by the process according to the invention are preferably suitable for melt processing, in particular as hotmelt adhesives, and for the production of sheets, tubes, profiles, injection moulded parts, fibres, coatings and foams, or for processing from solution or dispersion as an adhesive, impregnating resin, coating resin or laminating resin, or for the production of foams, microcapsules or fibres.

The particular advantage of the etherified melamine resin condensates prepared by the direct synthesis process and having average molar masses of 500 to 50 000 is that, owing to the higher melt viscosity compared with customary triazine derivative precondensates, such as melamine/formaldehyde precondensates, they can be processed by melt processing methods, like thermoplastics, and hardness and flexibility of the products produced therefrom can be adjusted in a wide property range.

The proportion of volatile cleavage products during the curing of the etherified melamine resin condensates prepared by the direct synthesis process, during the shaping of the melt to give the product, is dramatically reduced compared with customary moulding materials based on low molecular weight aminoplast precondensates. Consequently, crack-free products can be produced from the etherified melamine resin condensates in short cycle times.

Preferred fields of use of the etherified melamine resin condensates prepared by the direct synthesis process are hotmelt adhesives and the production of sheets, tubes, profiles, injection moulded parts, fibres and foams.

If they contain no fillers or further reactive polymers, the etherified melamine resin condensates prepared by the direct synthesis process are soluble in polar solvents of the type consisting of C₁-C₁₀-alcohols, dimethylformamide or dimethyl sulphoxide in concentrations of up to 60% by mass. The solutions or dispersions are suitable as an adhesive, impregnating composition, coating resin or laminating resin formulation or for the production of foams, microcapsules or fibres. The advantages of the solutions or dispersions of the etherified melamine resin condensates prepared by the direct synthesis process over customary triazine resin precondensates consist in the higher viscosity and the better levelling properties resulting therefrom or higher strengths of uncured intermediates in fibre or foam production.

The object is also achieved by melamine resin products which are produced using the etherified melamine resin condensates prepared by the process according to the invention.

The invention is explained in more detail below for an embodiment with reference to the figures of the drawings.

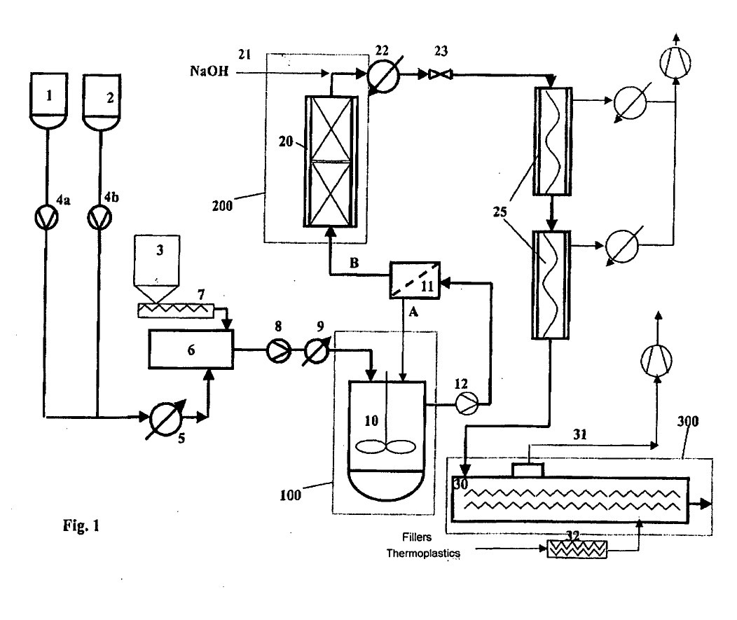

FIG. 1 shows a flow diagram of an embodiment of the process according to the invention.

Below, an embodiment of the continuous direct synthesis process according to the invention is described schematically. In the present example, three reaction stages 100, 200, 300 are used.

In the example described here, starting materials used are melamine, formaldehyde and methanol. Alternatively, other aldehydes and alcohols may also be used.

From a storage container for methanol 1 and a storage container for the aqueous 37% strength formaldehyde solution 2, the starting materials are fed via metering pumps 4a, 4b to a continuous mixer 6 for solids (in particular powders) and liquids. Both starting materials are preheated in a first preheater 5.

From a storage container for melamine 3, melamine is fed continuously by means of a solids metering apparatus 7 to the solids inlet of the mixer 6. The mixer 6 ensures that a homogeneous suspension of methanol, formaldehyde and water forms.

A pressure boosting pump 8 transports this suspension via a second preheater 9 to the first reaction stage 100, which is in the form of a continuous stirred reactor 10. In this first reactor 10, melamine is reacted with the other starting materials at temperatures between 70 and 140° C. and a pressure between 2 and 30 bar. Continuous stirred vessels are distinguished by particularly thorough mixing of the reactor content since the stirrers used can be adjusted to the properties of the starting materials and products of the reaction. Instead of a stirred reactor, it is in principle also possible to use a reactor cascade comprising more than one continuous stirred vessel.

The heterogeneous reaction product contained in the first reactor 10 is a suspension, which is subsequently separated into a solids-rich phase A and a virtually solids-free phase B (clear solution).

From an overflow of the first reactor 10, which overflow is not shown here, the suspension is taken off by means of a second pump 12 and fed to a solid-liquid phase separation apparatus 11. In the present embodiment, the solid-liquid phase separation apparatus is in the form of a crossflow filter. Alternatively, however, centrifuges, in particular disc centrifuges, or hydrocyclones may also be used as the solid-liquid phase separation apparatus 11. In principle, it is also possible here for the solid-liquid phase separation apparatus 11 to be formed as a plurality of stages (hydrocyclone).

The undissolved melamine and/or the undissolved melamine reaction products form the solids-rich phase A, which is recycled to the first reactor 10.

The solids-poor phase B is fed as a clear solution for further reaction to a second reactor 20 of the second reaction stage 200, which is in the form of a tubular reactor. In principle, the second reaction stage may also consist of more than one reactor container.

In the second reactor 20, the resin solution is etherified and further methylolated. For improving the mixing in the second reactor 20, the latter has static mixers and/or packings. The reaction (etherification, further methylolation) is effected in the second reaction stage under acidic conditions, at a pH between 5 and 6.

An NaOH solution is metered 21 into the homogeneous reaction product (melamine resin precondensate) of the second reactor 20, at the exit of the second reaction stage, for establishing a pH greater than 9. The melamine resin precondensate is fed to an evaporator stage 25 via a heat exchanger 22 for cooling the melamine resin precondensate and a throttle valve 23.

This evaporator stage 25 may consist of one or more evaporators, it being possible for the evaporators used to be falling-film evaporators, rotation evaporators or other evaporator designs.

The concentrated melamine resin precondensate is then fed to the third reaction stage 300 comprising a reactor 30 which is suitable for the reaction of highly viscous products and which is in the form of a continuous kneader here. An additive is added to the melt by a side metering means 32. Furthermore, the kneader 30 has a take-off 31 for readily volatile reaction products.

In its design, the invention is not limited to the abovementioned preferred embodiments. Rather, a number of variants is conceivable, which also make use of the process according to the invention in fundamentally different types of designs.

### LIST OF REFERENCE NUMERALS

1 Storage container for methanol

2 Storage container for formaldehyde

3 Storage container for melamine

4a,b Metering pumps

5 First preheater

6 Mixer

7 Solids metering apparatus

8 Pressure boosting pump

9 Second preheater

10 First reactor

11 Solid-liquid phase separation apparatus

12 Circulating pump

20 Second reactor (tubular reactor)

21 NaOH metering

22 Product cooler

23 Expansion valve

25 Evaporator (two-stage)

30 Third reactor (mixer, kneader)

31 Removal of readily volatile reaction products

32 Solids addition (fillers, thermoplastics)

100 First reaction stage

200 Second reaction stage

300 Third reaction stage

A Solids-rich phase

B Solids-poor phase (clear reaction solution)

1-25. (canceled)

26. A process for the synthesis of a liquid melamine resin, wherein
a) melamine, at least one aldehyde and at least one alcohol are fed to a continuous first reaction stage which has at least one stirred vessel and are reacted therein,
b) the reaction mixture, such as a suspension, is fed to a solid-liquid phase separation apparatus for separation into a solids-rich phase (A) and a solids-poor phase (B),
c) the solids-rich phase (A) present after the solid-liquid phase separation is recycled to the first reaction stage and
d) the solids-poor phase (B) present after the solid-liquid phase separation is fed to further processing steps, such as transported to a second reaction stage and further reacted there.

27. The process according to claim 26, wherein the solids-rich phase (A) is rich in undissolved melamine.

28. The process according to claim 26, wherein the reaction product is taken off as a suspension from an overflow of a reactor of the first reaction stage, such as of the last reactor of the first reaction stage, and transported into the solid-liquid phase separation apparatus.

29. The process according to claim 26, wherein the solid-liquid phase separation apparatus is in the form of a hydrocyclone, in the form of a centrifuge, such as in the form of a disc centrifuge, or in the form of a filter.

30. The process according to claim 26, wherein at least one alcohol, such as methanol, is used and at least one aldehyde, such as a solution of formaldehyde (37% strength) in water and methanol, is used.

31. The process according to claim 26, wherein the reactants are homogeneously premixed in a continuous mixer before the first reaction stage.

32. The process according to claim 26, wherein the reaction takes place in at least one reactor of the first reaction stage at temperatures between 70 and 140° C. and at a pressure between 2 and 30 bar.

33. The process according to claim 26, wherein, after the solid-liquid phase separation apparatus, the solids-poor phase (B) is fed to at least one continuous second reaction stage, such as at least one tubular reactor for further etherification.

34. The process according to claim 33, wherein the reaction in the second reaction stage is carried out under acidic conditions, such as at a pH between 5 and 6.

35. The process according to claim 33, wherein the second reaction stage is carried out in the presence of heterogeneous acidic catalysts, such as acidic ion exchangers.

36. The process according to claim 33, wherein at least one reactor of the second reaction stage has mixing elements, such as static mixers or packings or both.

37. The process according to claim 33, wherein homogeneous catalysts are mixed with the reaction mixture before the second reaction stage.

38. The process according to claim 33, wherein, after the second reaction stage, a pH of more than 9 is established, such as by metering in sodium hydroxide solution.

39. The process according to claim 33, wherein the reaction product of at least one second reactor in alcoholic solution is concentrated in at least one evaporation step, and C₄-C₁₈-alcohols, diols of the type HO—R—OH and/or tetrahydric alcohols based on erythritol are added to the melamine resin precondensate before, during and/or after the concentration, and the concentrated melamine resin precondensate is reacted in a third reaction stage by means of a mixer, such as a kneader.

40. The process according to claim 39, wherein at least one diol of the type HO—R—OH having molar masses of 62 to 20,000 or a mixture of at least two diols of the type HO—R—OH having molar masses of 62 to 20,000 are used, wherein the substituent R is selected from one of the following structures
C₂-C₁₈-alkylene,
CH(CH₃)—CH₂—O—(C₂-C₁₂)-alkylene-O—CH₂—CH(CH₃)—,
CH(CH₃)—CH₂—O—(C₂-C₁₂)-arylene-O—CH₂—CH(CH₃)—,
(CH₂—CH₂—CH₂—CH₂—CH₂—CO)ₓ—(CH₂—CHR)_{y}—,
[CH₂—CH₂—O—CH₂—CH₂]ₙ—,
[CH₂—CH(CH₃)—O—CH₂—CH(CH₃)]ₙ—,
[O—CH₂—CH₂—CH₂—CH₂]ₙ—,
[(CH₂)₂₋₈—O—CO—(C₆-C₁₄)-arylene-CO—O—(CH₂)₂₋₈]ₙ—,
[(CH₂)₂₋₈—O—CO—(C₂-C₁₂)-alkylene-CO—O—(CH₂)₂₋₈]ₙ—,
in which n=1 to 200; x=5 to 15; 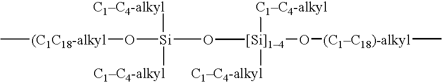
polyester sequences containing siloxane groups and of the type
[(X)ᵣ—O—CO—(Y)ₛ—CO—O—(X)ᵣ]—,
in which 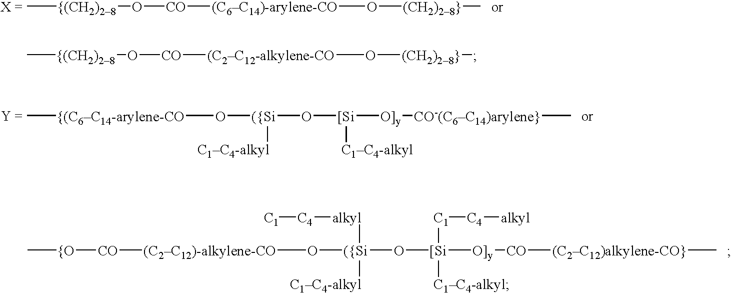
in which r denotes 1 to 70; s denotes 1 to 70 and y denotes 3 to 50;
polyether sequences containing siloxane groups of the type 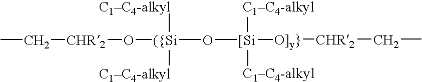
in which R′₂ denotes H; C₁-C₄-alkyl and y denotes 3 to 50;
sequences based on alkylene oxide adducts of melamine of the type 2-amino-4,6-di(C₂-C₄)alkyleneamino-1,3,5-triazine sequences, or
phenol ether sequences based on dihydric phenols and C₂-C₈-diols of the type
(C₂-C₈)alkylene-O—(C₆-C₁₈)-arylene-O—(C₂-C₈)-alkylene sequences.

41. The process according to claim 39, wherein the etherified melamine resin condensates are mixtures having average molar masses of 500 to 2500 and comprise tris(methoxymethylamino)triazine and higher molecular weight oligomers thereof.

42. The process according to claim 39, wherein, before and/or during the concentration, such as before the first and/or before the second evaporator stage, and/or after the concentration, such as before the second reaction stage, acids and/or acid anhydrides dissolved in alcohol or water are added to the melamine resin precondensate.

43. The process according to claim 39, wherein the concentrated melamine resin precondensate obtained after the evaporation has a concentration of 95 to 99% by weight.

44. The process according to claim 39, wherein the evaporation of the low molecular weight components is effected in two stages.

45. The process according to claim 39, wherein the kneader is a continuously operating extruder which is at least partly self-purging and has vacuum devolatilization.

46. The process according to claim 39, wherein the kneader used is a twin-screw extruder having devolatilization zones.

47. The process according to claim 39, wherein, in the continuous kneader, additionally up to 75% by mass of fillers or reinforcing fibres or both are present, additionally, reactive polymers of the type consisting of at least one of ethylene copolymers, maleic anhydride copolymers, modified maleic anhydride copolymers, poly(meth)acrylates, polyamides, polyesters or polyurethanes are incorporated, and up to 2% by mass, based in each case on the etherified melamine resin condensates, of stabilizers, UV absorbers or auxiliaries that are incorporated.

48. The process according to claim 39, wherein the melamine resin condensate is discharged and granulated after a third reaction stage.

49. Melamine resin products produced by means of a melamine resin condensate etherified by a direct synthesis process according to claim 26.
